(19) United States
(12) Patent Application Publication
(10) Pub. No.: US 2004/0030666 A1
(43) Pub. Date: Feb. 12, 2004

(54) Method of designing a multi-stage compressor rotor

(76) Inventors: John J. Marra, Jupiter, FL (US); Jonathan D. Schmid, Palm Beach Gardens, FL (US); Steven P. Kuzmeski, Manchester, CT (US); David A. Borzillo, Jupiter, FL (US)

Correspondence Address: Pratt & Whitney, 400 Main Street, M/S 132-13, East Hartford, CT, 06108, US

(21) Appl. No.: 10/633,961

(22) Filed: Aug. 4, 2003

Related U.S. Application Data
(63) Continuation of application No. 09/469,147, filed on Dec. 21, 1999, now abandoned.
(60) Provisional application No. 60/146,527, filed on Jul. 30, 1999.

(51) Int. Cl. G06N 5/02

(52) U.S. Cl. 706/48

(57) ABSTRACT

A method of designing a multi-stage rotor for the low pressure compressor of a gas turbine engine uses a knowledge-based product model software program to create a parametric, generative product model. The product model is embodied in a knowledge-based engineering system. The model is created by the program through user selection of various structural feature options available for the rotor. The product model software program uses its internal knowledge-base of configuration-dependent parameter relationships and rules to design the model. Various types of analyses may be conducted to validate the model. The model may be changed, if necessary, as a result of the analyses. The computer-generated model of the low pressure compressor rotor is available as an output file for various uses, including as an input to a program for controlling creation of parametric models of tooling to manufacture the rotor.

### CROSS-REFERENCE TO RELATED APPLICATIONS

This application claims the benefit of U.S. Provisional Application No. 60/146,527, filed Jul. 30, 1999.

### TECHNICAL FIELD

This invention relates to computer-based methods of designing products, and more particularly to a computer-based method of designing a multi-stage rotor for a low-pressure compressor (LPC), as used in a gas turbine engine.

### BACKGROUND ART

An aircraft gas turbine engine generally comprises a compression section, a combustion section and a turbine section. Each section works on the working fluid in a well-known manner to generate thrust. The compressor and turbine both comprise a plurality of airfoil blades attached to rotating disks or rings in successive stages to form rotor assemblies.

The rotor assembly of a compressor is disposed for rotating operation within a shroud assembly attached to the inside of the engine casing. The shroud assembly includes successive stages of stator vanes which extend radially inward from the shroud between successive stages of the rotor blades. The radially outer ends of the rotor blades extend into close proximity with outer air seals and the shroud. Similarly, the radially inner ends of the stator vanes extend into close proximity, or rubbing contact, with portions of the compressor rotor assembly. The resulting limited clearances are intended to minimize air leakage and thus improve efficiency and performance.

Design of a multi-stage low-pressure compressor (LPC) rotor assembly is typically a complex and time-consuming activity when done in the conventional manner. Numerous computations and design iterations and modifications require months of the designer's time when done in conventional “manual” fashion. Clearly, such delays and complexities complicate the design effort and contribute to costs.

Competitive pressures are forcing turbine engine manufacturers to reduce product development times, minimize design iterations, and react rapidly to changing markets and customers. Concurrent Engineering replaces the traditional sequential design process with parallel efforts; moreover, Knowledge-Based Engineering (KBE) exploits collected knowledge, information and experience to enhance and accelerate the design process. A general discussion of the use of KBE is contained in a paper entitled “Use of Knowledge-Based Engineering in Compressor Rotor Design” by John Marra, presented at the International Gas Turbine & Aeroengine Congress & Exposition, Houston, Tex., Jun. 5-8, 1995 and published by ASME. This paper describes very generally the capabilities and benefits of using such a KBE system.

Moreover, it is known to design various products using a computer-aided design (“CAD”) system, a computer-aided manufacturing (“CAM”) system, and/or a computer-aided engineering (“CAE”) system. For sake of convenience, each of these similar types of systems is referred to hereinafter as a CAD system. A CAD system is a computer-based product design system implemented in software executing on a workstation. A CAD system allows the user to develop a product design or definition through development of a corresponding product model. The model is then typically used throughout the product development and manufacturing process. An example is the popular Unigraphics system commercially available from Unigraphics Solutions, Inc. (hereinafter “Unigraphics”).

In addition to CAD systems, another type of computer-based product design system is known as a “Knowledge-Based Engineering” (“KBE”) system. As noted in the above-mentioned paper, a KBE system is a software tool that enables an organization to develop product model software, typically object-oriented, that can automate engineering definitions of products. The KBE system product model requires a set of engineering definitions of products. The KBE system product model requires a set of engineering rules related to design and manufacturing, a thorough description of all relevant possible product configurations, and a product definition consisting of geometric and non-geometric parameters which unambiguously define a product. An example is the popular ICAD system commercially available from Knowledge Technologies, Inc. KBE systems are a complement to, rather than a replacement for, CAD systems.

An ICAD-developed program is object-oriented in the sense that the overall product model is decomposed into its constituent components or features whose parameters are individually defined. The ICAD-developed programs harness the knowledge base of an organization's resident experts in the form of design and manufacturing rules and best practices relating to the product to be designed. An ICAD product model software program facilitates rapid automated engineering product design, thereby allowing high quality products to get to market quicker.

The ICAD system allows the software engineer to develop product model software programs that create parametric, three-dimensional, geometric models of products to be manufactured. The software engineer utilizes a proprietary ICAD object-oriented programming language, which is based on the industry standard LISP language, to develop a product model software program that designs and manipulates desired geometric features of the product model. The product model software program enables the capturing of the engineering expertise of each product development discipline throughout the entire product design process. Included are not only the product geometry but also the product non-geometry, which includes product configuration, development processes, standard engineering methods and manufacturing rules. The resulting model configuration and parameter data, which typically satisfy the model design requirements, comprise the output of the product model software program in ICAD from which the actual product may be manufactured. This output comprises a file containing data (e.g., dimensions) defining the various parameters and configuration features associated with each component or element of the product.

Also, the product model software program typically performs a “what if” analysis on the model by allowing the user to change model configuration and/or parameter values and then assess the resulting product design. Other analyses (e.g., a fatigue life analysis) may be run to assess various model features with regard to such functional characteristics as performance, durability and manufacturability. These characteristics generally relate to the manufacturing and operation of a product designed by the product model software program. They are typically defined in terms of boundaries or limits on the various physical parameters of each product feature. The limits have been developed over time based on knowledge accumulated through past design, manufacturing, performance, and durability experience. Essentially, these parameters comprise rules against which the proposed product model design is measured. The rules generally comprise numbers that define physical design limits or constraints for each physical product parameter. Use of these historically developed parameters, analyses, and design procedures in this way is typically referred to as product “rule-based design” or “knowledge-based design.” The rules determine whether the resulting product design will satisfy the component design requirements and is manufacturable or not, given various modern manufacturing processes. The rules for a particular product design are pre-programmed-into the product model software program for that specific product.

The ICAD system provides an excellent tool for developing software product models, and thus supplements the organization's primary CAD system. For the product model created in the ICAD system to be useful throughout the entire product development process, the model is transported into a CAD system for further manipulation.

However, it remains for the product modeler and designer to identify and assemble an appropriate knowledge base suitable for the element or assembly being modeled, and to then create appropriate processes for the computer-based usage of the knowledge base by the designer to obtain the desired model. Such an effort, though challenging the creative talents, is capable of providing significant benefits in the rapid design of products and the attendant avoidance or reduction of need to make and test successive hardware models.

### DISCLOSURE OF INVENTION

An object of the present invention is to provide a computer-based method of creating a parametric, geometric product model-of a rotor assembly for the low-pressure compressor (LPC) of a gas turbine engine.

Another object of the present invention is to provide a computer-based method of creating a parametric, generative product model in a KBE system.

According to an aspect of the present invention, a method of designing the rotor assembly for the low-pressure compressor of a gas turbine engine utilizes a knowledge-based product model software program for generating a parametric, geometric model of the LPC rotor assembly. The computer-generated model of the LPC rotor assembly may be used to guide the development of a tooling model which is in turn used to manufacture the LPC. The resulting product model may implement many different configurations of the structural features of the LPC. The product model is created by the program through user selection of various structural feature options available for the LPC, as well as the entry of appropriate performance data and flow path geometry description. The LPC components are configured by the program according to rules that account for accessibility, manufacturability and historical “best practices.”

During a geometry generation phase, the program calculates allowable stresses, calls a ring/disk profile synthesis program to generate a weight-optimized shape that meets the stress constraints and applies geometry profiles to the LPC cross section via the blending of shapes. The resulting design information may be output in several forms.

The foregoing and other objects, features and advantages of the present invention will become more apparent in light of the following detailed description of exemplary embodiments thereof as illustrated in the accompanying drawings.

### BRIEF DESCRIPTION OF DRAWINGS

FIG. 1 is a graphical, axial section of the upper half of a low-pressure compressor, including the rotor assembly model formed in accordance with the modeling process of the invention.

FIG. 2, which includes FIGS. 2A-2E, is a flow chart of steps performed by the product model software in creating the low-pressure rotor assembly model depicted in FIG. 1.

FIG. 3 is a block diagram of a workstation within which the program of FIG. 2 is implemented.

FIG. 4 is an illustration of an exemplary graphical user interface displayed to the user of the product model software program and which facilitates entry into the program of desired selections for analytical calculations.

FIG. 5 is a stick figure representation of the rotor being modeled, as provided by the program.

FIG. 6, which includes FIGS. 6A-6C, depicts the rule for placement of knife edges and welds as a function of flowpath slope.

FIG. 7 is a graphical, axial section of the upper half of the low-pressure compressor rotor assembly of FIG. 1, absent blades, both as provided by the modeling process of the invention and as the resulting manufactured product.

FIG. 8 is an illustration of an exemplary graphical user interface, displayed to the user, which facilitates determination of adequate design of the rotor front hub against buckling.

FIG. 9 is an illustration of an exemplary graphical user interface, displayed to the user, which provides a report of design information (weight).

FIG. 10 is an illustration of an exemplary graphical user interface, displayed to the user, which guides the user in determining the types of files and design information to be output to the CAD system.

### BEST MODE FOR CARRYING OUT THE INVENTION

Referring to the figures in general, in an exemplary embodiment of the broadest scope of the present invention, the invention generally comprises a method embodied in a knowledge-based, product model software program that creates a model of a rotor assembly for the low pressure compressor (LPC) of a gas turbine engine. The resulting product may then be manufactured from the model. The product model software program may preferably be embodied in the aforementioned ICAD system, commercially available from Knowledge Technologies, Inc., and operating within a workstation, such as that available from Sun Microsystems or Silicon Graphics. The method of the invention enables the rapid creation and manipulation of a parametric, geometric model of the rotor assembly of a LPC. Because the rotor assembly has a uniform or determined geometry of revolution about the axis of the LPC, it is, in the main, only necessary to define and depict the upper axial section of the rotor assembly in creating the model for the entire assembly.

During program operation, the user enters configuration and parameter data regarding various structural features of the LPC, and particularly the rotor assembly. This information is typically entered using a keyboard or mouse associated with the workstation. The user is guided by graphical user interfaces (“GUIs”) containing information provided on a visual display screen associated with the workstation. The product model software program compares the input design information against a knowledge base of information stored as part of the program. This determines whether any design constraints have been violated which would cause the rotor assembly to not satisfy the design requirements or be non-producible using modern manufacturing techniques. If so, the model is invalid. The information comprises a pre-programmed knowledge base of configuration dependent parameter relationships and rules regarding acceptable durability, manufacturing and performance design limits for the rotor assembly. The visual model may then be manipulated by changing various parameters or attributes associated with corresponding components of the rotor assembly.

The product model software program may also perform a fatigue life analysis and/or a buckling analysis on an attachment portion (e.g., the hub flange) of the rotor assembly model. Features of the model may be changed, depending upon the results of the analysis. Once creation of a valid model is complete, the product model software program outputs a file containing model configuration and parameter data for the manufacturing tooling. Other computer programs may then use this output file in a desired manner (such as for re-creating the model in a CAD system and/or for the set up and control of the manufacturing tooling). The product model software also creates a design report and a nonparametric geometry model.

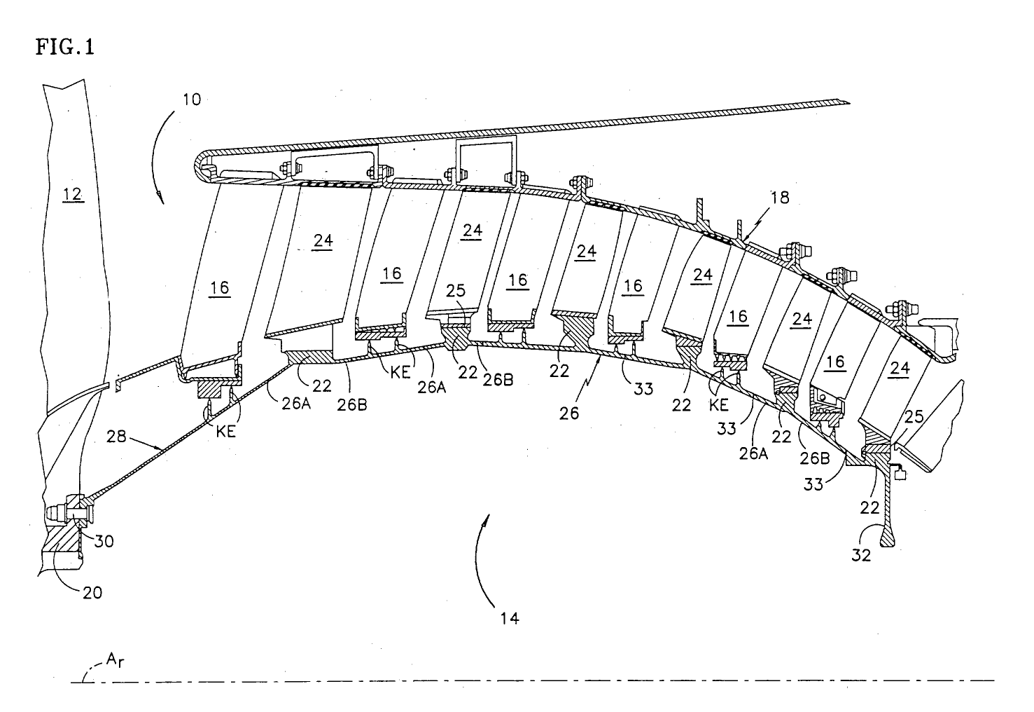

FIG. 1 illustrates an exemplary embodiment of an upper axial section of the low-pressure compressor LPC 10 of a gas turbine engine (not shown). The LPC 10 is of the axial flow type, and is preceded herein and connected, in part, to a fan 12. The LPC 10 is followed by a high-pressure compressor, not shown. In a conventional design, the LPC 10 includes a rotor assembly 14, and multiple stages of stator vanes 16. The stator vanes are mounted substantially in a fixed manner to a casing 18 which surrounds the LPC 10. The blades of fan 12 are supported by a central hub 20 having its axis on the axis of the engine. The axis Aᵣ of the rotor assembly 14 is similarly on the axis of the engine, and is connected to and supported by the hub 20.

The rotor assembly (hereinafter “rotor”) 14 consists of a number of axially spaced stages (seven stages being shown and described hereafter), each including a ring 22 (sometimes termed “disk”). The rings 22 each serve as the mount for a plurality of rotor blades 24 spaced circumferentially there around. The blades 24 are typically seated and mounted in axial slots 25 formed in the radially outer surfaces of the rings 22. The rings 22 also provide the structural foundation to rotor 14. The rings 22 are inter connected by a so-called “backbone,” which includes the relatively thinner, and axially longer spacers 26 extending axially between the rings 22 and formed integrally therewith. Each spacer 26 is typically formed by joining, as by welding, two arms 26A and 26B extending from opposite ends of the adjacent pair of rings 22. The forward end of the rotor 14 includes a hub flange 28 which extends forwardly and radially inwardly from the forward most ring 22, and is securely connected to the fan hub 20, as by a series of bolts 30. The rotor 14 is supported in cantilever fashion at fan hub 20. A stiffener disk 32 extends radially inward from the aft-most ring 22 to provide additional rigidity to the rotor 14. The inner diameter, or bore, in stiffener disk 32 is sized to allow the requisite structural properties to the disk remaining unsupported at its center.

Pairs of “knife edges,” K.E., extend radially outward from-the spacers 26 between successive rings 22 and serve to provide a sliding-contact seal with the respective stator vanes 16 as rotor 14 rotates. The knife edges K.E. of a pair are closely spaced to each other and may be on one or the other, or one of the pair on each, of the spacer arms 26A, 26B extending from the opposite sides of rings 22, depending upon the placement of the weld 33 which joins the adjacent pairs of spacer arms 26A, 26B.

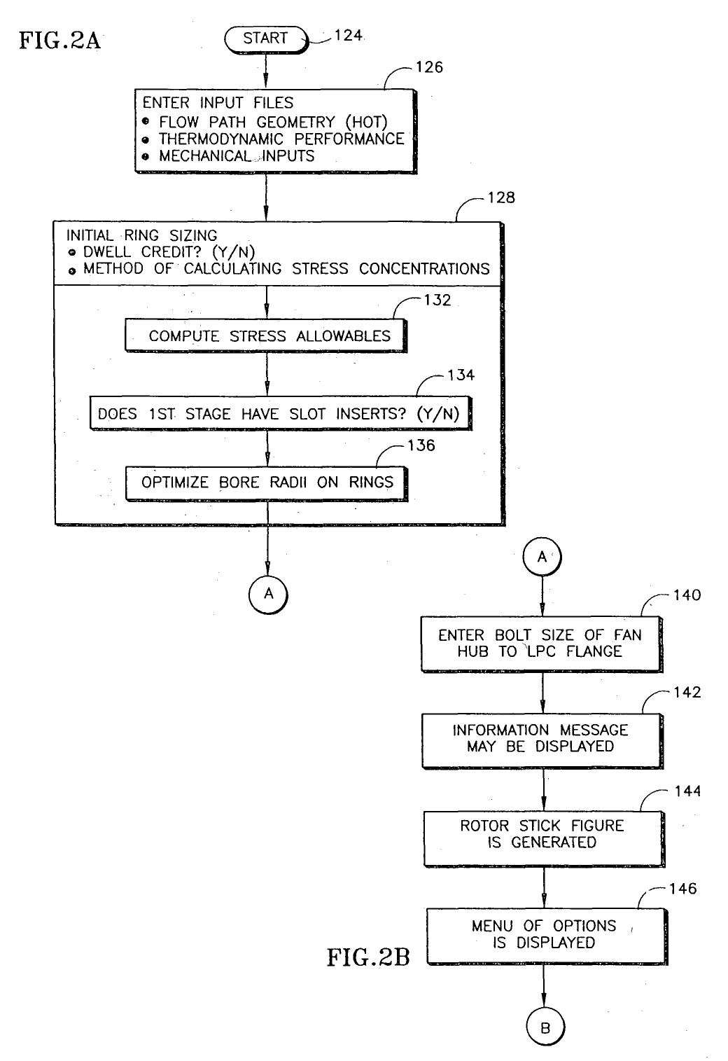

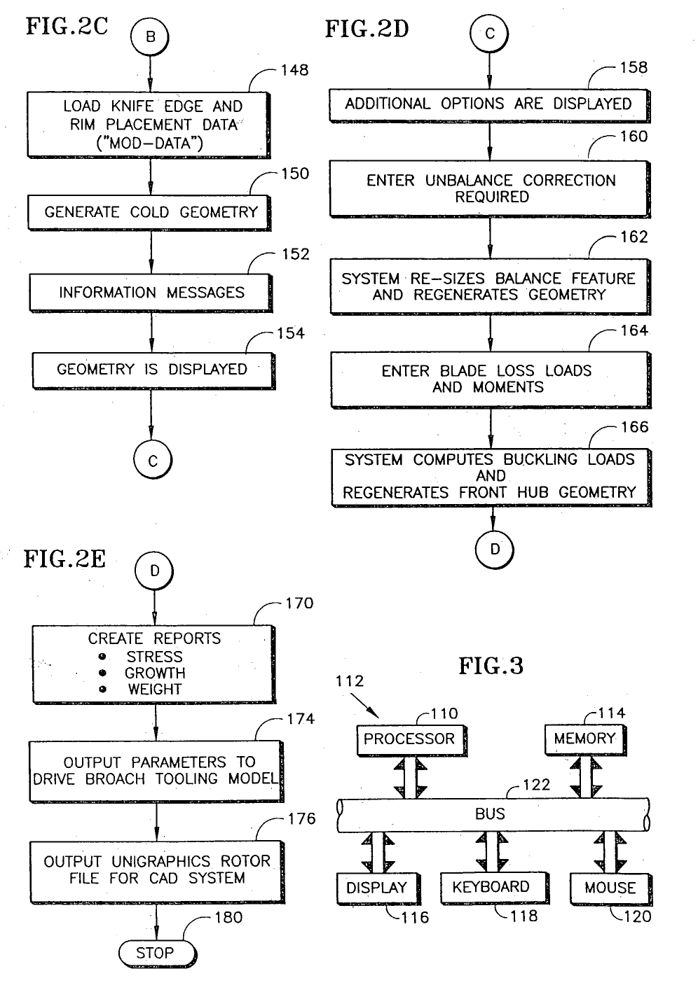

Referring to FIG. 2, there is illustrated a flow chart of steps performed by an exemplary embodiment of a product model software program in creating the rotor model. The program code is preferably written in the proprietary ICAD object-oriented programming language, which is based on the industry standard LISP language. The program executes on a computer processor 110 within a workstation 112, such as that illustrated in FIG. 3. The workstation 112 may also contain a memory 114 for storing program code and calculated data, a visual display screen 116 for displaying information to the user along with the rotor model 14 after it has been created, and a keyboard 118 and a mouse 120 that are both used to input information to the processor 110 and memory 114. These various devices are interconnected by a bus 122.

After an enter or start step 124 in the flow chart of FIG. 2, the user enters several input files containing various forms of data at step 126. Included in these input files are the Flowpath Geometry (Hot), the Thermodynamic Performance of the system, and the various Mechanical Inputs. Examples of the Flowpath Geometry include the shape of blades/vanes, foil count, etc. When viewed in a planar manner, the highly complex twisted shape of the airfoil will appear as a parallelogram or trapezoid, defined by the leading and trailing edges of the airfoil, as well as the root and tip of the airfoil. The foil count can vary from a low of about 50 to a high of about 150, as limited and determined by aerodynamics and/or mechanical packaging. Examples of Thermodynamic Performance include temperatures, pressures, speeds, etc. Examples of the Mechanical Inputs include attachment types, number of bolts, etc. The data input with these files in step 126 are used by the program at various points during program execution in creating the rotor model 14.

Throughout program execution, various GUIs guide the user while entering data and information. These GUIs display various model configuration and parameter data selections to the user, and the user selects a desired default data value, or enters a desired data value, using the keyboard 118 or mouse 120. As is common for each dimensional value (and for other types of parameter inputs, described hereinafter), the user may enter a desired value, or the user can select a default value offered to the user on the GUI. The default values are part of the knowledge base of parameters related to the low pressure compressor rotor whose values are pre-programmed into the product model software program. Besides default values for parameters or attributes, the knowledge base may also contain constraints on parameter inputs. These constraints and default values may comprise either a single value or range of values. For example, a parameter value may be greater than or less than a certain value. Also, the constraints and defaults may be derived from mathematical equations. A constraint or default value can either be dependent or independent of other parameters.

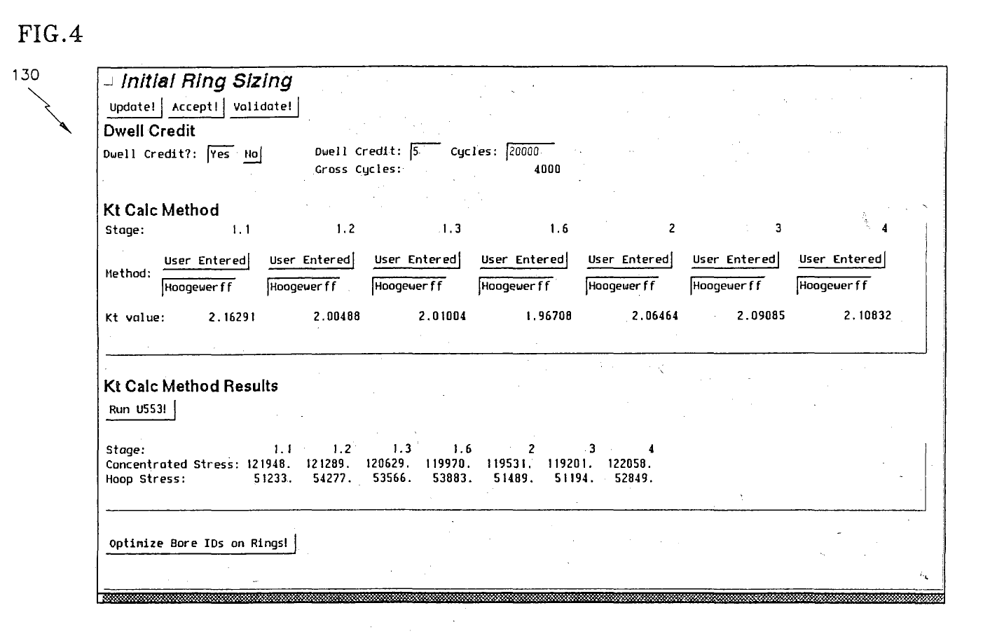

After entering the input file data in step 126, the flow chart proceeds to step 128 which provides for initial sizing of the rings 22. This step asks whether or not a dwell credit is to be taken and if yes, what amount, e.g., 5. This sizing step also provides an option for the method used in calculating stress concentrations in the rings 22. Two options include the known Hugleworf and Abraham techniques, with the user being also permitted to enter a custom defined calculation technique. The Initial Ring Sizing GUI 130 of FIG. 4 depicts these aspects of the selection and calculation process. It should be noted at this juncture that except for the exemplary rotor 14 of FIG. 1, the rotor 14 described hereinafter will include seven stages and thus, seven rings 22. In accordance with historical tradition, those stages or rings 22 are often designated, from forward to aft, 1.1, 1.2, 1.3, 1.6, 2, 3, and 4. Thus, the ring sizing process is conducted for each of those seven rings 22.

Subordinate steps in the initial ring sizing process, following step 128, include step 132 which computes the stress allowable of the respective rings 22, followed by step 134 which asks whether the slot(s) 25 in the ring 22 of the first stage have an insert or not, and by step 136 which seeks to optimize the inner diameters, or bore radii, of the rings 22. The computation of the stress allowable in step 132 can be done by known or proprietary stress analysis techniques, and determines the fatigue life, burst margin and stress concentrations for the respective element. The step 136 of optimizing the bore radii of the respective rings 22 determines the bore radii to be sufficiently small to allow tooling to attach to the bore I.D. and permit a broach operation to clear the welds at the joined spacer arms 26A, 26B. This process recurs iteratively to establish optimum ring size. A COPE/CONMIN-based ring/disk profile synthesis program, available from Engineering Design Optimization, Inc., is called to generate a weight-optimized shape that meets the stress constraints.

Following the sizing of the rings 22, the routine moves to step 140 at which the user enters the size of bolt 30 which joins the rotor flange 28 to the fan hub 20. Next, as represented by step 142, information messages may be generated and displayed to serve as a checkpoint and to determine whether additional steps external to the program need to be taken.

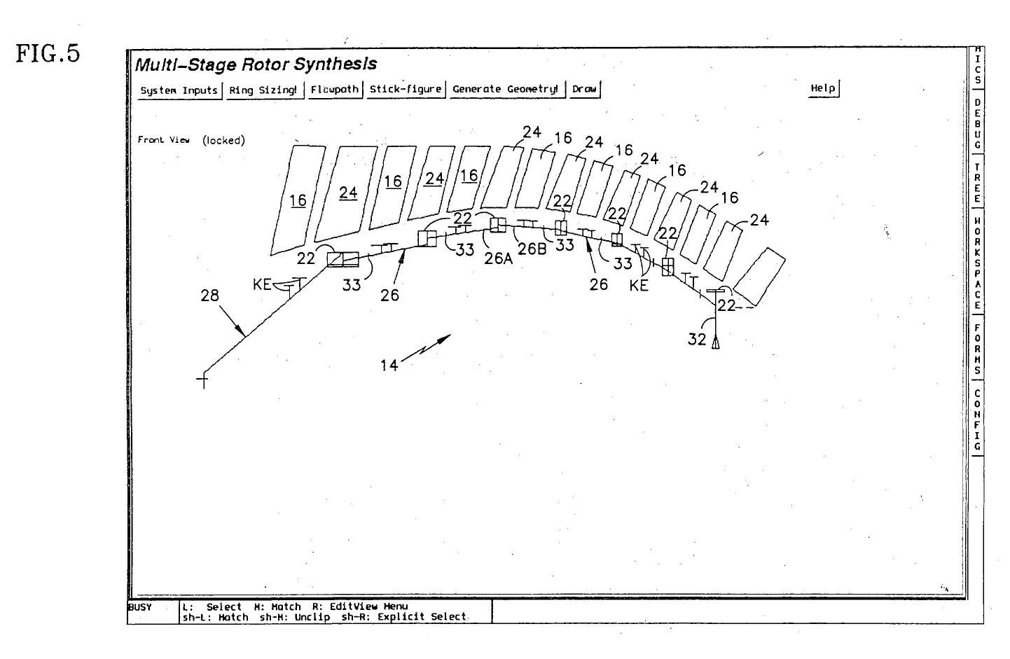

Following appropriate response to any such identified needs in step 142, the program, at step 144, may generate and display a relatively basic but useful stick figure of rotor 14, as depicted in FIG. 5. The stick figure rotor 14 of FIG. 5 shows the user/engineer a general arrangement of the elements of the rotor and provides an early view of how the rotor assembly will eventually appear. The figure may also be used for configuration trade studies.

Following the generation and display of the rotor model 14 stick figure, a menu of options is displayed at 146. Those options permit additional analyses to be conducted and afford the ability to modify the rotor model stick figure-as needed. Models may be saved for reuse. At this time it is also appropriate for the user designing the model of rotor 14 to interact with the designer of the stator portion of the LPC 10 to coordinate the placement of shrouds at the I.D. of the stator vanes 16 (not shown in detail), as well as the sizing and placement of knife-edge seal lands.

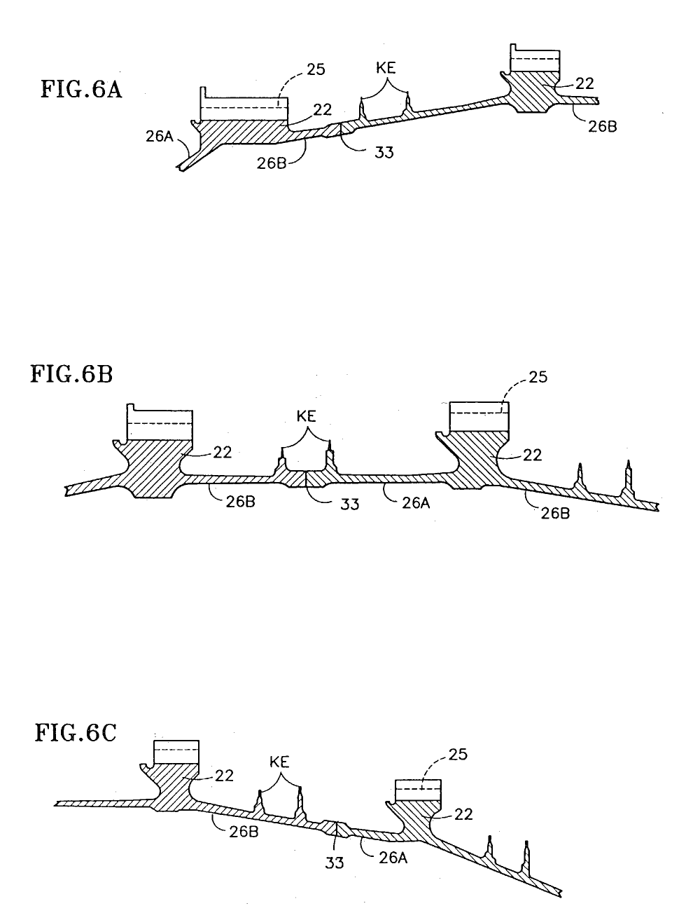

Having coordinated the location of the knife edge (K.E.) seal lands as a stationary part of the LPC 10, the design flow proceeds to step 148 for entry of knife edge (K.E.) and rim placement data. That data will be determined, at least in part, by the aforementioned establishment of the positioning of stator vane I.D. shrouds and knife-edge seal lands. Moreover, rules establishing the placement of the welds 33 relative to the knife edges K.E., as well as the constraints on the elevation of the weld stock relative to the “live rim” of an adjacent ring 22 will have been stored in the knowledge base of the system. More specifically, the location/length of knife edges, K.E., are set by a requirement for clearance (for the tooling, i.e., broach, or possibly milling machine) below the live rim of the next succeeding ring 22, viewed from forward to aft. The live rim is that annular region of unbroken material radially inward of slots 25. The creation of slots 25 and other types of broaching operations in and on the rings 22 occur before the welds 33 are made at the joints of spacer arms 26A and 26B to join successive stage. For this reason, the knife edges K.E. must be below the O.D. of the live rim of the ring 22 with which the KEs are an integral part prior to welding. Thus, as shown in FIG. 6, FIG. 6A depicts a positive sloping flowpath, which prevents the KEs from being on the elevated trailing spacer arm 26B and thus places them on the forward spacer arm 26A of the next succeeding ring 22 and similarly determines the relative positioning of the weld 33; FIG. 6B depicts a flat flowpath, which enables the KEs to be placed on either spacer arm 26B or 26A or preferably, as shown, one on each arm with the weld 33 between; and FIG. 6C depicts a negative sloping flow path which enables the KEs to be placed on the trailing spacer arm 26B and similarly determines the relative positioning of weld 33. If both KEs violate the live rim constraint, one spacer arm 26A or 26B is moved downward the smallest amount to make one knife edge KE pass the live rim constraint, and the weld 33 is positioned accordingly. In each instance, the weld stock of a weld 33 preceding or following a particular ring 22 must not extend radially above the live rim of that ring.

Following step 148, the routine generates the “cold” geometry of the rotor 14 at step 150. To this point the determinations for the sizes of the respective rings 22 has been based on “hot” conditions under which they experience the greatest stresses, however the actual manufacture of the rings 22 and rotor 14 will be under “cold” conditions. Thus, step 150 adjusts the sizing of the rings 22 and rotor 14 for “cold” or ambient conditions, based on known “hot” to “cold” size and geometric relations. The COPE/CONMIN ring synthesis program mentioned earlier is again called to assist in this phase of shape generation.

At step 152 the routine may provide additional information messages, such as the most limiting condition, e.g., growth. This type of information is in the further conduct of the product modeling process.

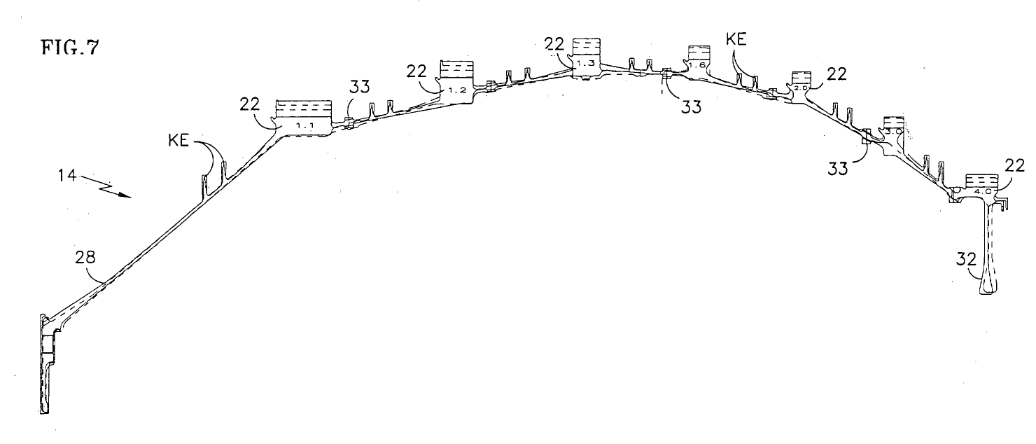

Then, at step 154, the geometry of the modeled rotor 14 is displayed. This computer-created geometric model of rotor 14, absent the rotor blades, is depicted in solid line in FIG. 7, and compares very closely with the resulting manufactured product which differs only in the small amounts represented by the broken lines in the Figure.

At step 158, additional options for use in the design of a rotor 14 are available to the user. For instance, it is here possible to perform an analysis of the hub flange 28's susceptibility to buckling or distortion. Appropriate corrections may be made in subsequent steps of the design routine.

Then, at step 160, correction values may be entered to correct for rotary unbalances created by welding and any other predictable effects of the manufacturing process. At step 162, the corrective values entered at step 160 are utilized to re-size the affected regions to achieve the necessary rotary balance and to then regenerate the geometry of the rotor model 14 in an improved state.

Further provision is made, at step 164, to introduce data representative of the loss of a blade from the fan 12. This effectively enters loads and moments that would be imposed on the rotor 14 via its connection with fan 12 via the fan hub 20.

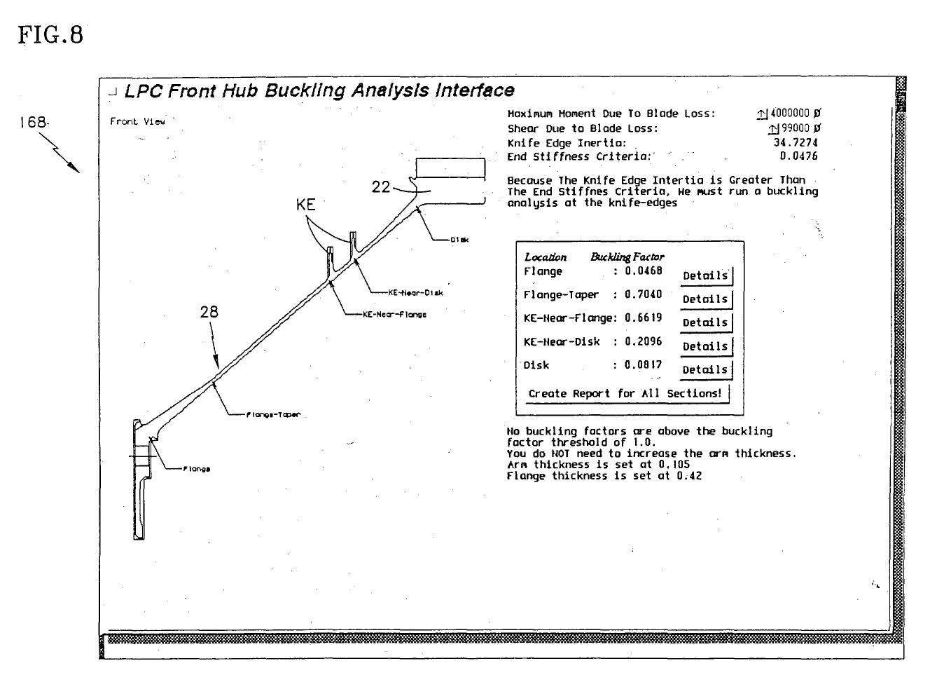

At step 166 the system computes buckling loads based on the entries made in the several preceding steps, provides a resulting analysis as depicted in the GUI 168 of FIG. 8, and regenerates the model geometry for the hub flange 28 as appropriate.

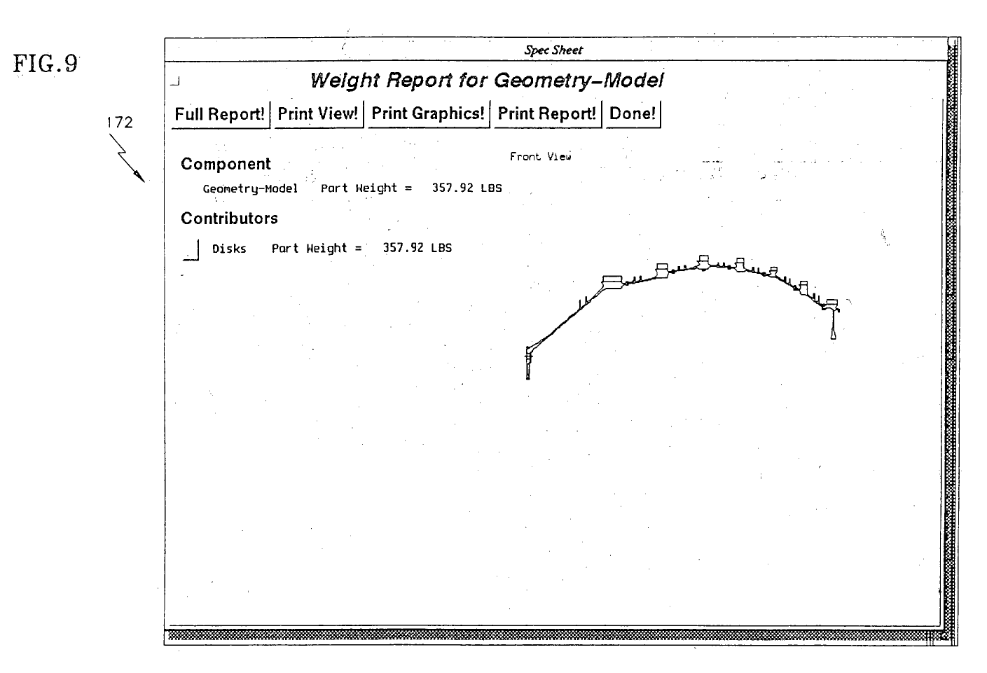

At this point the design phase of the geometry for the model of rotor 14 may be substantially complete; however, additional facets of the design and manufacturing process require additional actions. Specifically, at step 170, the system creates reports of the user's selection. These reports are typically for purposes of coordination with others in the design and manufacturing process and may also be useful in the certification process of the engine. These reports typically include stress, growth, weight, and others. The GUI 172 of FIG. 9 is an example of a weight report provided by the system. These reports represent a determination by the system of the designated parameter or characteristic based on the stored data, e.g. type and weight of materials, as well as the determined geometry of the model and appropriate correlating algorithms.

Following creation of any desired/required reports, the product model software program, at step 174, provides an output of the resulting parameters for the purpose of controlling the parametric modeling and design of the tooling which will manufacture the rotor 14. Typically, that tooling will include rough and finish turning, broaching, E.B. -welding, and possibly others. Thus, the result of modeling the rotor 14 is to not only provide a geometrical model of the product itself, but also to provide as an output file, the geometric data/parameters which are in turn used as an input file to a computer program for controlling parametric models of the design of the tooling required to manufacture the product. This data is determined by the program from known and stored relationships between the geometry of the product model and the dimensional requirements of the tooling needed to manufacture the product to the desired geometry.

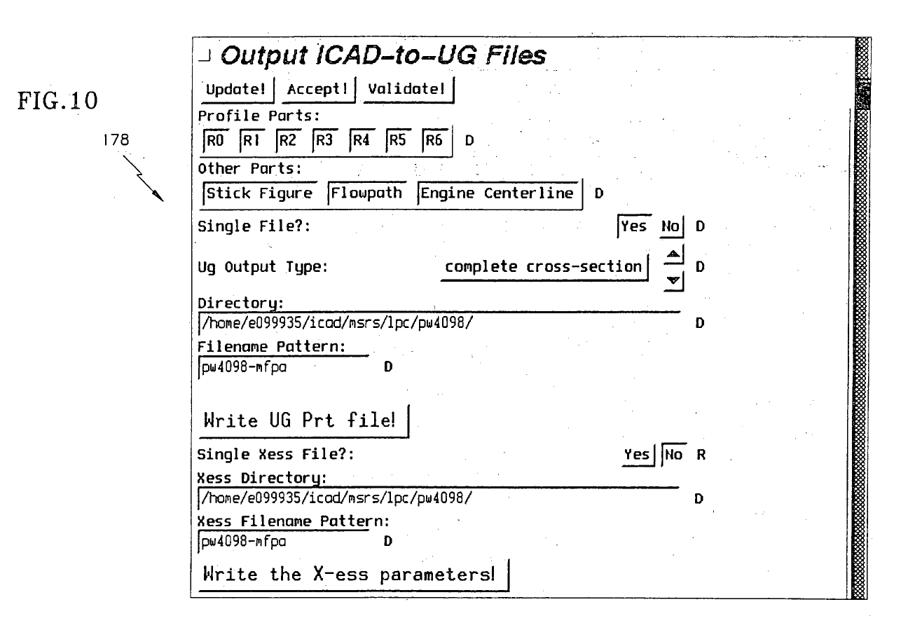

Step 176 of the routine involves the output of the ICAD-to-Unigraphics files for use in the UG CAD system. These files comprehensively define the geometry of the model rotor 14, contain some parameter data, and form the basis for further definition of the parameters of the product in the CAD system. These files also include the corresponding Boolean operations (i.e., the rotor model update commands of “unite,” “subtract” and “intersect.”) The GUI 178 of FIG. 10 depicts the instructional form and options available to the user for formatting and delivering the ICAD files to UG files. Various cross-sections of the ICAD model may be delivered to UG.

The ICAD model design routine is completed at step 180.

Although the invention has been described and illustrated with respect to the exemplary embodiments thereof, it should be understood by those skilled in the art that the foregoing and various other changes, omissions and additions may be made without departing from the spirit and scope of the invention.

We claim:

1. A method of creating a model of a low pressure compressor rotor for a gas turbine engine, comprising the steps of:
creating a knowledge base of information having a plurality of rules with respect to a corresponding plurality of parameters of associated elements of the low pressure compressor rotor, wherein the knowledge base comprises at least one data value for each one of the plurality of rules;
entering a desired data value for a selected one of the plurality of parameters of an associated element of the low pressure compressor rotor;
comparing the entered desired data value for the selected one of the plurality of parameters with the corresponding at least one data value in the knowledge base for the corresponding one of the plurality of rules; and
if the result of the step of comparing is such that the entered desired data value for the selected one of the plurality of parameters is determined to have a first predetermined relationship with respect to the corresponding at least one data value in the knowledge base for the selected one of the plurality of rules, then creating a geometric representation of the selected one of the plurality of parameters of the associated element of the low pressure compressor rotor.

2. The method of claim 1, wherein the step of creating a geometric representation of the selected one of the plurality of parameters of the associated element of the low pressure compressor rotor further comprises the step of updating the model of the low pressure compressor rotor with the selected one of the plurality of parameters of the associated element of the low pressure compressor rotor.

3. The method of claim 1, wherein if the result of the step of comparing is such that the entered desired data value for the selected one of the plurality of parameters is determined to have a second predetermined relationship with respect to the corresponding at least one data value in the knowledge base for the selected one of the plurality of rules, then modifying the entered desired data value for the selected one of the plurality of parameters.

4. The method of claim 3, further comprising the steps of:
comparing the modified data value for the selected one of the plurality of parameters with the corresponding at least one data value in the knowledge base for the corresponding one of the plurality of rules; and
if the result of the step of comparing is such that the modified data value for the selected one of the plurality of parameters is determined to be of the first predetermined relationship with respect to the corresponding at least one data value in the knowledge base for the corresponding one of the plurality of rules, then creating a geometric representation of the selected one of the plurality of parameters of the associated element of the low pressure compressor rotor.

5. The method of claim 1, further comprising the step of storing the created knowledge base of information.

6. The method of claim 1, further comprising the step of displaying the created geometric representation of the selected one of the plurality of parameters of the associated element of the low pressure compressor rotor.

7. The method of claim 1, wherein the associated elements of the low pressure compressor rotor include a plurality of axially spaced rings, the rings including spacer means for connecting and establishing the spacing between, successive rings.

8. The method of claim 7, wherein the spacer means between successive rings include a knife edge member, successive rings are connected by welds in successive spacer means, and wherein the knowledge base includes rules for the placement of the welds relative to the knife edge members.

9. The method of claim 1, wherein the associated elements of the low pressure compressor rotor include a plurality of axially spaced rings, and wherein the knowledge base includes rules for sizing the rings.

10. The method of claim 1, further comprising the step of analyzing the created geometric representation of the selected one of the plurality of parameters of the associated element of the low pressure compressor rotor.

11. The method of claim 10, wherein the step of analyzing the created geometric representation of the selected one of the plurality of parameters of the associated elements of the low pressure compressor rotor further comprises the step of performing a durability analysis on the created geometric representation of the selected one of the plurality of parameters of the associated elements of the low pressure compressor rotor.

12. The method of claim 1, wherein the step of creating the geometric representation of the selected one of the plurality of parameters of the associated element of the low pressure compressor rotor further comprises the step of creating the model of the low pressure compressor rotor.

13. The method of claim 1, wherein the at least one data value for some of the plurality of rules in the knowledge base comprises a numerical value.

14. The method of claim 1, wherein the step of entering a desired data value for a selected one of the plurality of parameters of an associated element of the low pressure compressor rotor comprises the steps of:
making available at least one data value for each one of the plurality of parameters of the associated element of the low pressure compressor rotor; and
selecting a desired data value for the selected one of the plurality of parameters of the associated element of the low pressure compressor rotor from the at least one data value made available for each one of the plurality of parameters of the associated element of the low pressure compressor rotor.

15. The method of claim 14, wherein the step of making available at least one data value for each one of the plurality of parameters of the associated element of the low pressure compressor rotor comprises the step of providing a visual display containing a graphic depiction of the at least one data value for each one of the plurality of parameters of the associated element of the low pressure compressor rotor.

16. The method of claim 1, further comprising the step of providing a file listing of a selected one or more of the plurality of parameters of the associated elements of the low pressure compressor rotor, wherein the file listing includes at least one of the entered desired data values for each one of the corresponding plurality of parameters of the low pressure compressor rotor elements.

17. The method of claim 16, wherein the step of providing a file listing of a selected one or more of the plurality of parameters of the associated elements of the low pressure compressor rotor further comprises the step of providing the file listing as an output from a knowledge-based engineering system.

18. The method of claim 17, wherein the step of providing the file listing of a selected one or more of the plurality of parameters of the associated elements of the low pressure compressor rotor as an output from a knowledge-based system further comprises the step of providing the file listing as an input file to a computer program for controlling parametric models of the design of the tooling for the manufacture of the low pressure compressor rotor.
